(19) United States
(12) Patent Application Publication
(10) Pub. No.: US 2012/0247603 A1
(43) Pub. Date: Oct. 4, 2012

(54) Method of manufacturing paper tube corner posts

(76) Inventor: Walter Brian Simms, Calhoun, GA (US)

(21) Appl. No.: 13/135,719

(22) Filed: Jul. 14, 2011

Related U.S. Application Data
(60) Provisional application No. 61/516,053, filed on Mar. 29, 2011.

(51) Int. Cl. F16L 9/14; B31C 11/04

(52) U.S. Cl. 138/141; 493/272

(57) ABSTRACT

An improved method of manufacturing support posts that are commonly formed from wound paper tubes. With this invention, a number of material layers are laminated together and formed in a continuous manner while they are still pliable. Materials are taken from a number of rolls that is equal to the number of layers required within the finished product. The individual layers are drawn through a glue station where adhesive is applied between each layer. The finished shape is created by bringing together all of the layers, then progressively folding them around a heated mandrel that has been shaped to match the inner hollow space of a formed paper tube corner post design.

### CROSS REFERENCE TO RELATED APPLICATIONS

This is based on the provisional application for patent Ser. No. 61/516,053, filed Mar. 29, 2011, titled Folded Paper Tube Construction.

### BACKGROUND OF THE INVENTION

1. Field of the Invention

This patent relates to corner posts typically formed from convolute wound paper tubes, which are used for cushioning and protecting packaged articles, such as furniture or large appliances. More particularly, this patent relates to an improved method of creating these formed tubular corner posts.

2. Description of the Related Art

Conventional wound paper tube corner posts are made by cutting paper to a specific length as adhesive is applied, then winding the paper around a cylindrical mandrel to form a round paper tube. Once wound and still malleable, the paper tubes are moved onto a shaped forming mandrel, where they are held under heat for a period of time, until the adhesives set, holding the material into the shape of that mandrel. The whole process has to stop in stages long enough for the winding/forming of each piece before they can be advanced to the next step. This slows down manufacturing considerably.

The current method of winding paper tubes prior to forming them into a corner post is inefficient. The rate of production is directly related to the number of layers required and the perimeter dimension of the finished product. These factors can increase the sheet width, thereby adding to the amount of time required for winding.

Several Patents disclose corner posts made of multiple layers of paper that are formed into a particular shape such as, Qiu U.S. Pat. No. 6,186,329 and Van De Camp U.S. Pat. No. 7,625,616 however, these and others are made by first winding the materials into a convolute paper tube, then forming the tubes into a desired shape.

Thus, it is the primary objective of the present invention to provide a method of manufacturing tubular type corner posts by bringing the accumulated layers of material together and forming them in a continuous operation, thereby dramatically increasing the production rate.

Still another object of the invention is to provide a method in which the use of varying material grades contained within a corner post design are incorporated as individual layers within the structure and don't require the separate process of skiving them together in a strong-weak-strong configuration.

Yet another advantage of the present invention is that the rolls of materials being used are of a reduced width as compared to those of a convolute wound paper tube operation, since all layers are laid down together instead of being wound from a single sheet that is wide enough to provide the required layers.

Other additional features will become apparent from the accompanying drawings, appended claims and description given.

### SUMMARY OF THE INVENTION

This invention relates to tubular corner posts, and more particularly to the method of manufacture for such devices. By having multiple, independent layers of materials laminated together and then folded into a specific corner post design, a tubular corner post can be created from a continuous flow of material. The resulting corner posts would have the same inner and outer walls exposed as the conventional convolute wound paper tube method. The independent layers can be comprised of varying material grades and widths with the abutting joints or edges being placed in any location along the perimeter of that design.

In making a corner post with this method, the number of layers within a design would determine the number of sheets or rolls of material to process. These materials are laminated together in a predetermined pattern, then progressively folded along the longitudinal axis around an elongated forming device (mandrel) that matches the interior hollow space of a selected shape. The materials are formed in a continuous manner for the length of the sheets or endlessly from a roll supply. The edges of the materials are terminated in one of several ways. Abutting edges of offset material for each layer can be placed anywhere along the perimeter, then overlapped by the following layer, with it's edges terminated elsewhere within the structure. The overlapping of aligned laminate edges can be bonded together at the point of contact and can be located anywhere along the perimeter as well. The edges of a narrow width layer of material can terminate anywhere within the lamination. The materials are continuously drawn over the mandrel, which is preferably heated, until the adhesive is set to hold the material in the proper shape. Individual pieces are then cut to length as the finished product advances.

### THE DRAWINGS

The drawings constitute a part of this specification and include exemplary embodiments to the invention, which may be embodied in various forms. It is to be understood that in some instances, various aspects of the invention may be shown exaggerated or enlarged to facilitate an understanding of the invention.

FIG. 1 is an illustration of the invention showing an overlapped bonding area for the material layers contained within the inner facing ribs of a particular corner post design.

FIG. 2 is a top plan view of the invention showing the shape of a mandrel conforming to the inner profile of a corner post design, (shaded area) and the end-to-end placement of the independent layers material ends (section A-A).

FIG. 3 is a top plan view of a corner post design showing the overlapped surfaces of the materials being joined along the inner right angle of the corner post design.

FIG. 4 is a top plan view of a corner post design showing the bonding area of overlapping materials being located within the hollow area created at the apex point.

FIG. 5 is a top plan view showing the bonding area of the overlapped materials being located within the recessed rib of a corner post design.

FIG. 6 is a top plan view of the materials being used set in an offset pattern as they leave the supply source.

FIG. 7 is a right side plan view of an equipment setup for forming materials in accordance with the present invention.

FIG. 8 is a top plan view showing the location of the material layers end-to end joints being peeled away from their respective locations contained within the perimeter of a corner post design.

### DETAILED DESCRIPTION OF THE INVENTION

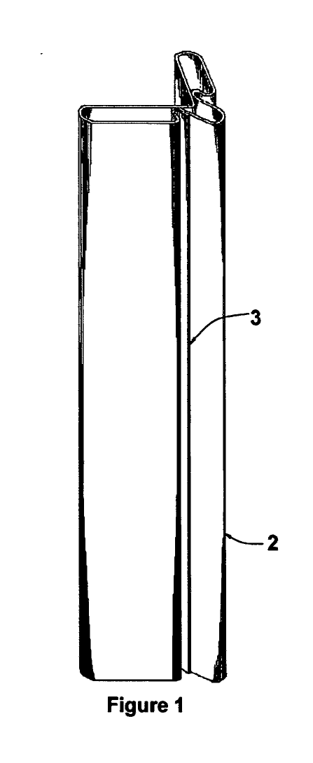

Turning to the drawings, the perspective view in FIG. 1 shows a resulting tubular type corner post 2 made according to the present invention, which is made without the tube winding process. One example, bonding joint 3, located within a ribbed area, is shown in accordance with this invention and others are exampled further on.

Conventional tubular corner post construction involves winding materials around a cylindrical mandrel, then ejecting the wound tube off of the mandrel, and while they are still malleable, form them into a desired shape. They are then held under pressure with heat applied, at different stages, until adhesives have set the desired shape. These wound paper tube corner posts may have varying grades of materials spliced together and may be formed into many geometrical shapes. However, they are all wound convolute paper tubes, which are made from a single sheet of material (materials), having as much sheet width as the number of layers required, multiplied by the shaping mandrels' perimeter dimension. This requires wide rolls of materials in creating the desired number of layers within a corner post design.

Typically, these corner posts are placed at each corner of an article between the product and the inside corners of the package. The corner posts protect the article against vertical (axial) and horizontal (lateral) forces. After manufacture, a product (typically a large appliance) is placed on or fastened to a pallet or base having dimensions greater than the width and depth of the appliance to accommodate corner posts. A protective sleeve, typically made of paperboard or corrugated board, is placed over the appliance to form the four sidewalls of the container. The corner posts are placed at each corner around the appliance and between the product and protective sleeve. At this point, a paperboard or corrugated top is placed over the package. Straps may be placed around the container to better secure the corner posts between the appliance and the container. The packaged appliances may then be stacked on top of each other for warehousing.

We have developed a completely different method of tubular corner post construction by forming independent layers of materials simultaneously in a continuous process directly around the mandrel of a desired shape. Varying or similar grades of materials that are cut to a width that is equal to, slightly larger or even narrower than the perimeter dimension of a chosen mandrel may be incorporated within the layers of a corner post design. These layers may also contain narrow strips of material embedded between other layers as well. With this invention, the use of narrower width materials is realized, since each layer is independent and so close in width to the perimeter dimension of the forming mandrel.

This method of construction is very different from that of the wound paper tube designs, but yields a similar product. However, with the present invention, corner posts can be made at a higher rate of speed and formed into any geometrical shape possible without the winding process at all.

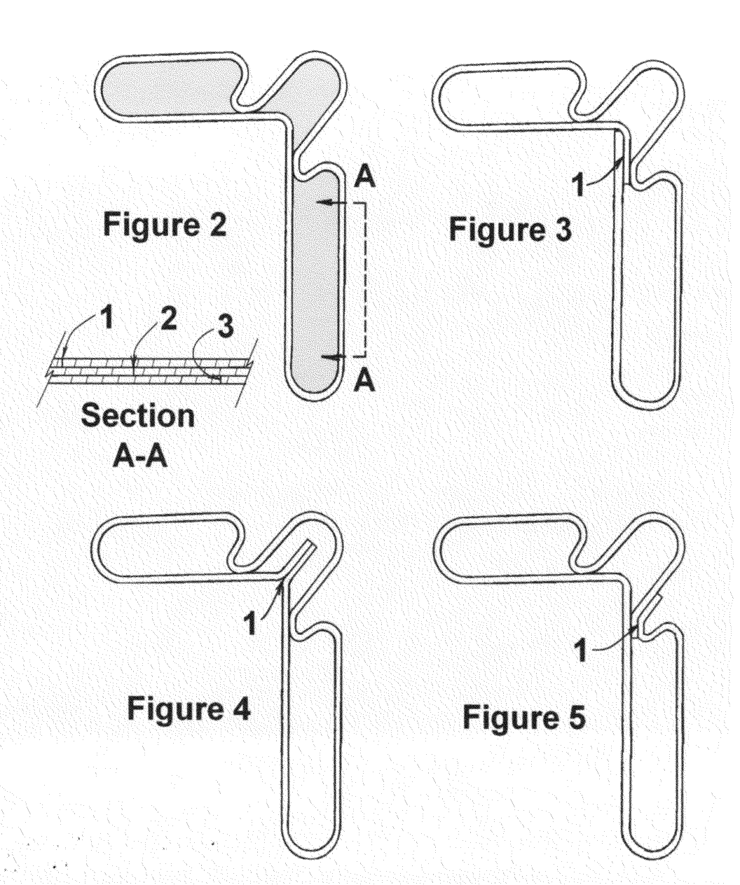

As an example, in a machinery setup for describing the present invention FIG. 7, all individually layered materials ends are brought together within the structure of the tubular corner post to a predetermined location. Shown in FIG. 7, materials are taken from Roll Stands 1 and drawn through a glue section 2. Adhesive is applied to the materials as required and they are then brought together over a roller section 3 for alignment. From this location, materials go through an area of transition 4, where they progress from a flat sheet into a desired finished shape, such as in FIG. 1. These corner posts are created by having a heated mandrel shaped to match the interior profile of a corner post design, such as the shaded area of FIG. 2 for one example. The mandrel section FIG. 7, 5 would be of sufficient length to enable the set of adhesives at a high rate of speed, thereby holding the materials into the chosen shape. This mandrel would be held rigidly in place at the material entry point and free floating at the exit point. The materials in this example are progressively formed around the heated mandrel by contoured rollers from above. Rough top belting would pull from below and this belting would be shaped to match the inner profile of the corner post design that is in direct contact with the packaged item.

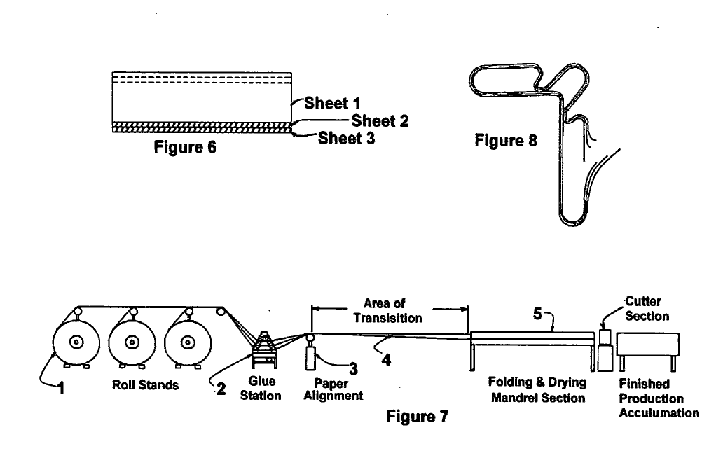

The material ends, by one method, may be brought together within each layer and joined end to end from an offset alignment at the Roll Stands FIG. 7, 1 as shown from above in FIG. 6. These materials would all have a width equal to the perimeter dimension of the chosen mandrel. This staggered arrangement comes together as shown in Section A-A, FIG. 2 and peeled away in FIG. 8. These end-to-end joints can be independently located anywhere along the perimeter of the corner post. Another method that the ends may be brought together within the scope of this invention would be to align all edges of the material layers on the Roll Stands. This material would be cut to a predetermined width that is greater than the perimeter dimension of the heated mandrel. The addition of approximately 1 inch would allow for an overlap surface of the materials once they have been formed around the heated mandrel. These overlapping surfaces may be located at any point along the perimeter of the mandrel FIGS. 3 & 5, or be contained within the hollow inner space FIG. 4, of the finished tubular corner post. Secondary adhesive may be placed along the overlapping surfaces for bonding.

Further methods, modifications and alternative embodiments of the invention are contemplated, which do not depart from the spirit and scope of the invention as defined by the foregoing teachings and appended claims. It is intended that the claims cover all such modifications that fall within their scope.

I claim as my invention:

1. An improved method of manufacture for tubular type corner posts comprising: a means for the compilation of multiple independent layers of materials that are laminated together, then simultaneously folded along the longitudinal axis around an elongated and specifically contoured mandrel, with the edges of said materials being brought together and bonded along a seam created between the material surfaces as they meet, thereby producing a formed tubular type corner post, having inner and outer walls exposed without the winding process.

2. The corner post of claim 1, wherein the layered materials being used are trimmed to a width that is equal to the perimeter or circumference dimension of the mandrel for a chosen corner post design, all of which layers are laminated together with their respective edges being set-up in a staggered or predetermined offset pattern at the source, thereby creating end-to-end abutting joints of the material within each layer once folded around the mandrel, all of which joints are spaced apart within the structure due to the offset pattern of each layer.

3. The corner post construction of claim 1, wherein the layered materials being used are of a width greater than the perimeter or circumference dimension of the mandrel for a selected corner post design, all of which independent material layers are laminated together with edges evenly aligned throughout, thereby creating an overlap of all material layers once folded, exposing a bonding seam along the length of the formed corner post.

4. The corner post construction of claim 1 further comprising: a means wherein the multiple layers of materials can be conjoined and shaped in a longitudinal direction of a continuous web of sheet material.

5. The corner post of claim 1 wherein the multiple layers of material are conjoined as individual sheets that are laid up as a whole, and/or, laid up independently and then formed into the corner post design.

6. The corner post of claim 1 wherein the multiple layers of material are conjoined as folded sheets from a single supply source and then formed into the corner post design.

7. The corner post of claim 1 wherein the multiple layers of sheet material are comprised of different material grades within, to achieve a desired compression strength for the corner post.

8. The corner post structure of claim 1 wherein the multiple layers of sheet material comprise sheets of various widths contained within the structure.

9. The corner post of claim 2 wherein the abutting joints produced may be positioned at any location along the perimeter of a layer within a corner post design.

10. The corner post of claim 3 wherein the bond seam created may be positioned at any location along the perimeter of a corner post design.
